(19) United States
(12) Patent Application Publication
(10) Pub. No.: US 2025/0113077 A1
(43) Pub. Date: Apr. 3, 2025

(54) METHODS AND SYSTEMS FOR DISPLAYING CONTENT DURING A PAUSE EVENT

(71) Applicant: Adeia Guides Inc., San Jose, CA (US)

(72) Inventors: Jean-Yves Couleaud, Mission Viejo, CA (US); Reda Harb, Tampa, FL (US)

(21) Appl. No.: 18/374,827

(22) Filed: Sep. 29, 2023

(51) Int. Cl. H04N 21/431; G06V 10/70; H04N 21/472

(52) U.S. Cl. CPC H04N 21/4312; G06V 10/768; H04N 21/47217

(57) ABSTRACT

There are provided systems and methods for displaying content to a user during a pause event of media content. The systems and methods comprise determining contextual information of the media content at the pause event, determining a visual effect based at least in part on the contextual information, modifying the media content based on the visual effect, and displaying, to a user, the modified media content during the pause event.

### FIELD

The present disclosure relates to methods and systems for displaying content and, more particularly, to systems and related processes for displaying content to a user during a pause event when accessing an over-the-top, OTT, service.

### BACKGROUND

In the past few years, the number of people turning to the internet for news, entertainment, education, and more has increased exponentially. Over-the-top (OTT) video consumption is consistently rising, with predictions that the online streaming market will be worth $1039 billion by the year 2027. There is heavy competition between OTT service providers, such as Netflix, Hulu, YouTube, Disney+, social media platforms, and the like, to promote their content to users and increase subscriber count, especially as new service providers enter the market. Most media platforms, OTT, Pay TV, or social media allow users to pause video programs using a remote control, a soft control on a touch screen or with a mouse, or via a voice assistant. When the media is paused, it is frame frozen. Most players apply a basic brightness filter (i.e., “greying”) to the frozen frame and overlay information such as date and time, program title, channel (if applicable), basic player controls, and “X-ray” features such as those on Prime Video®. More recently, advertisements are being displayed during these pause events. Accordingly, systems and methods are disclosed herein to improve upon and further overcome the shortcomings of paused media content.

### SUMMARY

Accordingly, in a first aspect of the disclosure, there is provided a method of modifying content for display at a user device during a pause event of media content, the method comprising: determining contextual information of a media content item at the pause event; determining a visual effect based at least in part on the contextual information; generating a modified media content item based on the visual effect; and displaying, to a user, the modified media content during the pause event.

In some examples, the method further comprises obtaining image data from the media content item at the pause event. In some examples, the contextual information is based on the image data.

In some examples, the image data is obtained with an automatic content recognition technique. In some examples, the method further comprises receiving a signal indicative of the pause event, wherein obtaining the image data is in response to receiving the signal indicative of the pause event.

In some examples, the media content comprises metadata, and the contextual information is determined from the metadata. In some examples, the method further comprises receiving a signal indicative of the pause event, wherein the metadata is fetched in response to receiving the signal indicative of the pause event.

In some examples, the method further comprises, prior to the pause event, monitoring the media content for changes in contextual information; storing the latest contextual information in cache; and in response to receiving a signal indicative of the pause event, using the contextual information in cache to determine the contextual information at the pause event.

In some examples, the method further comprises preloading, or prefetching, further media content items of the media content during the pause event in parallel to the displaying of the modified media content item during the pause event. Buffering, prefetching, or preloading an advance supply of audio samples or video frames in RAM, prevents disruption if there are momentary delays in transmission while the material is being played. In this way, the pause event can be used to buffer or preload further media content, such as teaser frames, in parallel to displaying the modified media content. A teaser frame frequently contains hinted, cryptic, curiosity-inducing messages, to pique audience interest and anticipation, as well as increase the hype of the advertised content before viewing.

In some examples, the method further comprises receiving a signal indicative of a play command; removing the visual effect; and displaying the preloaded media content item. For example, the media content may continue to play from the original paused location as if the visual effect was never displayed, or, from a later position in the media content based on the visual effect. By way of further example, if the visual effect was a slow motion effect, the media content may continue from the point of the slow motion effect.

In some examples, the method further comprises retrieving a user profile, the user profile indicative of a user-preferred visual effect. In some examples, the method further comprises storing the user-preferred visual effect in local storage on a user device. In some examples, the method further comprises determining the visual effect based at least in part on the user-preferred visual effect. In some examples, the method further comprises storing the user-preferred visual effect in the cloud and associating the user-preferred visual effect with the user profile.

In some examples, the contextual information comprises one or more of: media content type, genre, social context, cultural context, historical context, political context, educational context, character focus, scene direction or environmental data. For example, contextual information such as a main character focus (e.g., for blur effects) and scene direction (e.g., for appropriate particle animation) can be used by a user device to generate on.

In some examples, the genre is at least one of: action, adventure, comedy, drama, fantasy, horror, musicals, mystery, romance, science fiction, sports, thriller, western, animation, documentary, television, crime, biography, indie film, short film, period, history, or Bollywood.

In some examples, the visual effect comprises one or more of: a blur effect; vignette effect; particle effect; depth of field effect; a hue adjustment; a gamma adjustment; brightness adjustment; film grain effect; an audio-visual clip; an interactive poster; a plurality of frames of the media content; a slow-motion effect; a picture-in-picture overlay; or a reconstructed 3D representation of the image data.

In some examples, the visual effect comprises a teaser frame of the media content comprises media content items of the media content. In some examples, the teaser frame is selected from a plurality of buffered media content frames. In some examples, the visual effect comprises teaser frames of the media content. In some examples, the teaser frames are selected from a plurality of buffered media content frames. In some examples, the teaser frame(s) are particular I-frames indicated by a manifest file. In some examples, the teaser frames are associated with a separate manifest file. For example, in Apple HLS, there is a dedicated I-frame or keyframe only playlist.

In some examples, the method further comprises determining user device capabilities. In some examples, in response to the user device capabilities being below a threshold, the method is at least in part carried out in an over-the-top, OTT, media content service connected to the user device via the internet. In some examples, in response to the user device capabilities being above the threshold, the method is carried out at least in part on the user device.

In a second aspect of the disclosure, there is provided a non-transitory computer-readable medium having instructions encoded thereon which, when executed, cause a processor to carry out a method, the method comprising: determining contextual information of a media content item at a pause event; determining a visual effect based at least in part on the contextual information; generating a modified media content item based on the visual effect; and displaying, at a user device, the modified media content during the pause event.

In a third aspect, there is provided an apparatus for displaying content to a user during a pause event of media content, the apparatus comprising: transceiver circuitry, processing circuitry and a display device, the processing circuitry configured to: determine contextual information of a media content item of the media content at the pause event; determine a visual effect based at least in part on the contextual information; generate a modified media content item based on the visual effect; and display, via the display device, the modified media content item during the pause event.

In a fourth aspect there is provided a system for displaying content to a user during a pause event of media content, the system comprising: means for determining contextual information of a media content item of the media content at the pause event; means for determining a visual effect based at least in part on the contextual information; means for generating a modified the media content based on the visual effect; and means for displaying at a user device the modified media content item during the pause event. In some examples, the system further comprises a display device and/or a user device.

It should be noted that examples of the first aspect are compatible with examples of the second to fourth aspect, unless explicitly stated otherwise.

In a fifth aspect of the disclosure, there is provided a method for generating a manifest for adaptive bitrate media, the method comprising: receiving, from a user device, a request for media content delivery; determining a plurality of media content segments associated with the requested media content; determining contextual information of the media content segments; and generating the manifest, the manifest comprising: a plurality of uniform resource locators, URLs, indicating the location of the media content segments; and indications of contextual information associated with each media content segment, wherein the contextual information is associated with a visual effect to be applied to each media content segment during a pause event of the media content. In some examples, the method further comprises transmitting the manifest to the user device.

In some examples, the manifest further comprises instructions on how to modify each media content segment based on the visual effect.

In some examples, the method further comprises, during the pause event, receiving a request for further media content delivery. In some examples, the further media content is a further plurality of media content segments associated with the requested media content. In some examples, the further media content is visual effects associated with the media content segments referenced in the manifest.

In some examples, generating the manifest further comprises tagging the URLs with the contextual information.

In some examples, the request for content delivery comprises an indication to retrieve consecutive segments of the content. In some examples, the method further comprises instructions for caching the consecutive segments of the content in response to the request for content delivery comprising an indication to retrieve consecutive segments of the content.

In some examples, the method further comprises receiving a request for a user profile, the user profile is indicative of a user-preferred visual effect; and sending the user profile or an indication of the user-preferred visual effect to the user device. In some examples, the manifest comprises indications where the user-preferred visual effect can be used during the pause event.

In some examples, the contextual information comprises one or more of: media content type, genre, social context, cultural context, historical context, political context, educational context, character focus, scene direction or environmental data. For example, contextual information such as a main character focus (e.g., for blur effects) and scene direction (e.g., for appropriate particle animation) can be used by a user device to generate on.

In some examples, the genre is at least one of: action, adventure, comedy, drama, fantasy, horror, musicals, mystery, romance, science fiction, sports, thriller, western, animation, documentary, television, crime, biography, indie film, short film, period, history, or Bollywood.

In some examples, the visual effect comprises one or more of: a blur effect; vignette effect; particle effect; depth of field effect; a hue adjustment; a gamma adjustment; brightness adjustment; film grain effect; an audio-visual clip; an interactive poster; a plurality of frames of the media content; a slow-motion effect; a picture-in-picture overlay; or a reconstructed 3D representation of the image data.

In some examples, the visual effect comprises a teaser frame of the media content. In some examples, the teaser frame is selected from a plurality of buffered media content frames. In some examples, the visual effect comprises teaser frames of the media content. In some examples, the teaser frames are selected from at least one of: a plurality of buffered media content frames, the plurality of media content segments, a media content item associated with the requested media content, or the requested media content. In some examples, the teaser frame(s) are particular I-frames indicated by a manifest file. In some examples, the manifest file is associated with the media content or a separate manifest file. For example, in Apple HLS, there is a dedicated I-frame or keyframe only playlist.

Buffering, or preloading an advance supply of audio samples or video frames in RAM, may prevent disruption if there are momentary delays in transmission while the material is being played. In this way, the pause event can be used to buffer or preload further media content, such as teaser frames, in parallel to displaying the modified media content. A teaser frame frequently contains hinted, cryptic, curiosity-inducing messages, to pique audience interest and anticipation, as well as increase the hype of the advertised content before viewing.

In a sixth aspect of the disclosure, there is provided a non-transitory computer-readable medium having instructions encoded thereon which, when executed, cause a processor to carry out a method, the method comprising: receiving, from a user device, a request for media content delivery; determining a plurality of media content segments associated with the requested media content; determining contextual information of the media content segments; and generating a manifest, the manifest comprising: a plurality of uniform resource locators, URLs, indicating the location of the media content segments; and indications of contextual information associated with each media content segment, wherein the contextual information is associated with a visual effect to be applied to each media content segment during a pause event of the media content.

In a seventh aspect, there is provided an apparatus for generating a manifest for adaptive bitrate media, the apparatus comprising: transceiver circuitry, processing circuitry and a display device, the processing circuitry configured to: receive, from a user device, a request for media content delivery; determine a plurality of media content segments associated with the requested media content; determine contextual information of the media content segments; and generate the manifest, the manifest comprising: a plurality of uniform resource locators, URLs, indicating the location of the media content segments; and indications of contextual information associated with each media content segment, wherein the contextual information is associated with a visual effect to be applied to each media content segment during a pause event of the media content.

In an eighth aspect there is provided a system for generating a manifest for adaptive bitrate media, the system comprising: means for receiving, from a user device, a request for media content delivery; means for determining a plurality of media content segments associated with the requested media content; means for determining contextual information of the media content segments; and means for generating a manifest, the manifest comprising: a plurality of uniform resource locators, URLs, indicating the location of the media content segments; and indications of contextual information associated with each media content segment, wherein the contextual information is associated with a visual effect to be applied to each media content segment during a pause event of the media content.

It should be noted that examples of the first aspect are compatible with any of the examples of the second to eighth aspects.

Accordingly, there are presented herein methods, systems, and apparatus for generating modified content and/or generating a manifest for adaptive bitrate media. It should be understood that the methods, systems, and apparatus may apply to any OTT content, such as movies, programs, advertisements and the like. In general, the methods, systems, and apparatus apply to OTT platforms, but should not be thought to be limited to OTT platforms, per se. For example, the present disclosure would equally apply to set-top boxes, mobile devices, and applications thereon, such as pause events in gaming applications, loading screens and the like.

### BRIEF DESCRIPTION OF THE DRAWINGS

Embodiments of the invention are further described hereinafter with reference to the accompanying drawings, in which:

FIGS. 1A-1B illustrate implementations of the present disclosure, in particular added visual effects during a pause event of media content, in accordance with embodiments of the disclosure;

FIG. 2 illustrates a table comprising visual effects that can be applied to media content during a pause event, in accordance with embodiments of the disclosure;

FIG. 3 is a pictorial representation of variable bitrate media content, in accordance with some embodiments of the disclosure;

FIG. 4 is a pictorial representation of an adaptive bitrate request, in accordance with some embodiments of the disclosure;

FIG. 5 illustrates an exemplary pseudo-code for an adaptive bitrate request, in accordance with some embodiments of the disclosure.

FIG. 6 is a pictorial representation of a manifest for adaptive bitrate content, in accordance with some embodiments of the disclosure;

FIGS. 7 and 8 illustrate exemplary pseudo-code for flagging uniform resource locators when there is and is not a pause evet, and metadata in the form of contextual information, in accordance with some embodiments of the disclosure;

FIG. 9 illustrates an exemplary flowchart of the processing involved in displaying media content with a visual effect, in accordance with embodiments of the disclosure;

FIG. 10 illustrates an exemplary flowchart of the processing involved in detecting a pause event and monitoring steps prior to a pause event, in accordance with embodiments of the disclosure;

FIG. 11 illustrates an exemplary flowchart of the processing involved in removing a visual effect, in accordance with embodiments of the disclosure;

FIG. 12 illustrates an exemplary flowchart of the processing involved in retrieving user-preferred visual effects, in accordance with embodiments of the disclosure;

FIG. 13 illustrates an exemplary flowchart of the processing involved in generating a manifest for adaptive bitrate media content, in accordance with embodiments of the disclosure;

FIG. 14 illustrates an exemplary media transmission device, in accordance with some embodiments of the disclosure; and

FIG. 15 is a block diagram representing devices, components of each device, and data flow therebetween for an adaptive video streaming system, in accordance with some embodiments of the disclosure.

### DETAILED DESCRIPTION

Examples of the present disclosure propose to add visual effects to paused media content based on the contextual information in the paused scene. A plurality of visual effects could be used, such as: generating a slow-motion video of the previous or next few frames using optical flow algorithms or equivalent (to create intermediary frames where there are none, or an insufficient amount); adding blur/vignette and particle bokeh effects to the video in relation to what is happening in the scene (i.e., program type, mood of the scene . . . ) and the direction vectors of the scene's optical flow; adding sound effects to the paused media content; generating a 3D representation of the scene based on the previous or next few frames using 3D reconstruction methods, and optionally allowing the user to navigate the reconstructed 3D scene while paused; or generating a slide show of select scenes in the media content in relation to what was happening prior to when the media content was paused.

When users watch media content on content aggregators, or OTT services providers in general, they may pause the media content for a variety of different reasons, such as taking a break, being interrupted, or boredom. Paused media content is therefore a common occurrence. Static images, or simple “greying” of the paused media content and displaying a progress bar to the user, are visually unattractive and may not entice users to return to the content. Static images in particular are not entertaining nor stimulating to a user—and sometimes lead to confusion on whether the application has frozen or become unresponsive. Thus, a more attractive and stimulating presentation of the media content during such events is presented.

OTT is short for “over-the-top,” which refers to a method of media distribution that serves as an alternative to traditional satellite or cable television. We are entering a future in which most media is delivered and consumed via the internet. OTT technology is distributing more and more media each day. Some industry leaders advocate that we stop differentiating between OTT and broadcast TV entirely. An OTT streaming service is the application (“app”) or website that viewers turn to access their favorite programs and movies. These services are accessible on all sorts of internet-enabled devices, including smart TVs, gaming consoles, computers, laptops, smartphones, and tablets. Typically, OTT streaming services limit access to paying viewers. Viewers can pay for access on a pay-per-view basis, or they can subscribe for unlimited on-demand access to the platform. Sometimes, broadcasters monetize their content with sponsored advertisements.

There are many OTT streaming services on the market. Some of these are niche services, and others have broader offerings and are geared towards a more general audience. Some focus on OTT live streaming and others only offer on-demand content. Most offer free content, premium content, or a mix of both. What all OTT streaming services have in common is that they all use the internet to deliver video content.

In addition, the present disclosure may also be applied to loading or buffering moments in the media content. Users often want media content immediately and are presented within similarly unattractive “loading wheels” when the user selects the application while loading, authentication, reauthentication, and fetching of the media content item occurs. This is exaggerated for content aggregators because they typically require multiple application programming interfaces (APIs) to load content. The issue is also exaggerated for users with low bandwidth. Thus, a more attractive and stimulating presentation of the media content during such events is presented.

Moreover, users are often presented with advertisements across a variety of websites and platforms. In one approach, advertisements are targeted to particular users based on demographics, location, behavior (e.g., browsing behavior, device usage, etc.), user interests, etc. (e.g., targeted advertising). For example, in one approach, to target particular users with relevant advertisements, advertisers may access or maintain user profiles associated with particular users and select personalized advertisements based on the profiles. Additionally, in some approaches, advertisements may be targeted based on the content of a website or media asset a user is currently consuming. Thus, a pause event is an opportunity for advertisements to be displayed to a user. Utilizing the disclosures herein would create a visual effect on the media content item itself simultaneously to an advertisement, which would result in a more engaging advertisement. For example, when the media content item is paused, a visual effect can be applied to the media content item, the advertisement, or both.

Therefore, a system and method that is able to display visual effects to a user would be desirable. The visual effects used to modify media content items can be fetched just like a typical segment from adaptive bitrate technologies, or can be stored locally (e.g., cached) and applied to the media content item; in the latter example, the visual effect is therefore not dependent on bandwidth or authentication requests and can be applied immediately to the image on the paused media content. In addition, the visual effect being specific to the media content item, and more particularly to the context of the paused scene in the media content item, is uniquely engaging for the user.

Displaying a visual effect on paused media content, as opposed to not displaying any visual effect, can have several technical effects:
Visual Continuity: When a visual effect is displayed on paused media content, it can help maintain visual continuity. This means that even when playback is paused, the viewer continues to see the intended visual elements and effects that are relevant to the scene.
Enhanced Detail: Visual effects on paused media can bring out finer details in the frame that might not be apparent in the unaltered paused image. This can be particularly useful for analyzing scenes, appreciating artistic nuances, or scrutinizing specific aspects of the content;
Clarity and Emphasis: Visual effects can be used to emphasize certain elements or aspects of the paused frame. For example, highlighting a character's facial expression or a crucial object in the scene can enhance the viewer's understanding of the narrative or thematic elements;
Contextual Information: Visual effects can provide additional context or information to the viewer when media content is paused. This could involve adding annotations, subtitles, or graphical overlays to explain elements of the scene, such as character names or historical references;
Brand and Identity: In some cases, visual effects may be used for branding or promotional purposes when media content is paused. This could include displaying logos, promotional messages, or interactive elements related to the content or its creators; and
User Interface Elements: When media content is paused on digital platforms, visual effects may be interactable by a user through interface elements.

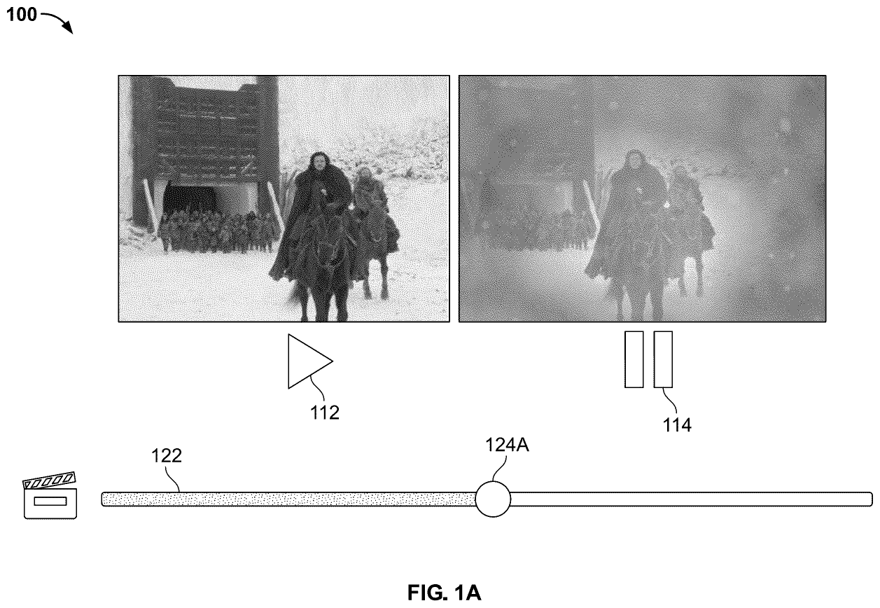

FIGS. 1A-1B illustrate implementations of the present disclosure, in particular, added visual effects during a pause event of media content, in accordance with embodiments of the disclosure. Shown is a media content item 100, that was in a played state, as indicated by the play button 112, and in a paused state, as indicated by pause icon 114. A progress bar 122 is also shown with a current position indicator 124A. In general, when media content is paused, a pause symbol or a play symbol may be displayed on the screen to indicate that the content has been paused. Additionally, some platforms may display a still frame media content item from the media content or a black screen. However, this can vary greatly depending on the platform and the type of media being played.

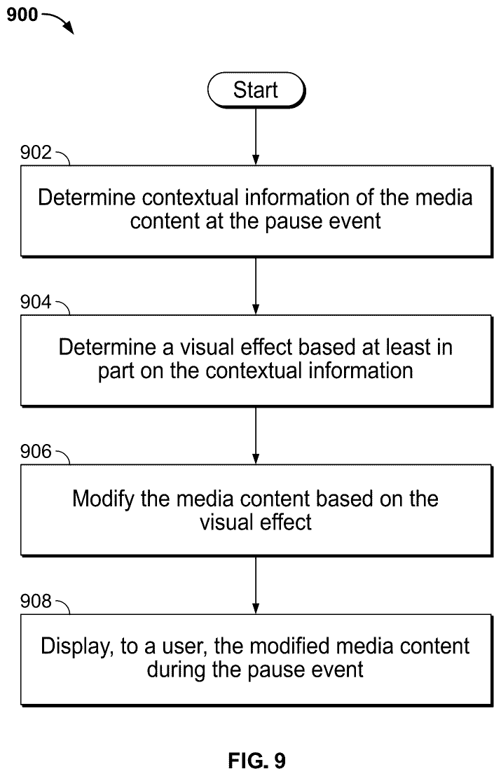

However, as shown in FIG. 1A, during a pause event with the present disclosure a plurality of visual effects specific to the scene have been applied to the media content item. Because the scene is in a cold environment, fog, vignette, snow particles, and bokeh have been applied to the media content item during the pause event. The process of applying visual effects is described below in relation to FIG. 9. Visual effects, commonly denoted as VFX, are a set of techniques and technologies employed in the realm of visual media production to augment or manipulate the appearance of filmed footage. These effects are applied to achieve outcomes that would be otherwise unattainable or impractical through conventional means, enhancing the overall visual quality and storytelling capabilities of a given production. Visual effects serve various purposes, ranging from the creation of entirely fictional elements to the enhancement of real-world scenes and environments.

The realm of visual effects encompasses a diverse array of methods and tools, including Computer-Generated Imagery (CGI), which involves the generation of digital imagery, such as objects, characters, or entire environments, utilizing specialized software and hardware. It is versatile and can be employed for a wide range of applications, from crafting lifelike creatures to simulating complex phenomena like explosions and altering the visual context of a scene. Moreover, particle effects, which are the simulation of natural phenomena like fire, smoke, rain, or dust, typically achieved through computer algorithms, contribute to the realism and immersion of scenes.

Visual effects represent an indispensable facet of contemporary filmmaking and visual storytelling. Their significance has grown in tandem with technological advancements, enabling filmmakers to embark on creative endeavors that would have previously been unfeasible or cost-prohibitive. Visual effects play an instrumental role in crafting immersive worlds, enhancing narrative impact, and elevating the visual aesthetics of motion pictures, television productions, video games, and various other forms of media.

In addition, visual effects encompass animated enhancements integrated into recorded footage to augment its visual appeal. Each distinct visual effect is typically represented as an individual file. Alternatively, visual effects may exhibit interrelated attributes, exemplified by instances such as the application of diverse lightning patterns to correspond with thunder-related elements within the visual narrative.

As shown in FIG. 1B, during the pause event, as indicated by pause icon 114, a plurality of visual effects specific to the scene have been applied to the media content. In particular, because the scene is an action scene, a blur, vignette, dust particulars and bokeh effect, have been applied to the media content item during the pause event. FIG. 1B shows the same media content item 100, but at a different position in the media content as shown by current position indicator 124B being later in the progress 122 of the media content. In this way, it is shown that different visual effects are shown to the user depending on the pause position of the media content. The process of applying visual effects is described below in relation to FIG. 9.

In this way, the media content is more engaging during a time when the media content is, most likely, at its least engaging; a pause event-something that the show creators previously had no creative control until this disclosure. Some possible factors that may influence the engagement level of visual effects are:
Emotion: Visual effects that evoke an emotional response from the user, such as humor, awe, or empathy, may be more engaging than those that are purely functional or decorative.
Relevance: Visual effects that are relevant to the look, feel, or brand of the content may be more engaging than those that are random or distracting.
Innovation: Visual effects that are innovative, creative, or surprising may be more engaging than those that are common or expected.

With an understanding of the possible factors that may influence the engagement of viewers, visual effects can be chosen based on contextual information of the paused scene. What is actually going on in the paused scene is a relevance factor, as described above, and is more immersive to the world the creators of the show have made. Some examples of visual effects that may have these factors are:
Cinemographs: These are still images with subtle motion elements, such as a flickering candle or a flowing river. They can create a sense of realism, intrigue, or beauty.
Motion graphics: These are animated graphics that can convey information, emotion, or style. They can include text, icons, shapes, or logos. They can enhance the clarity, appeal, or branding of the content.
Stop-motion animation: This is a technique where objects are moved in small increments and photographed to create the illusion of movement. It can create a sense of charm, nostalgia, or craftsmanship.
Transition effects: These are effects that change from one scene to another, such as wipes, fades, or zooms. They can create a sense of continuity, contrast, or excitement.
Text effects: These are effects that modify the appearance or behavior of text, such as color, size, font, or animation. They can create a sense of emphasis, personality, or interactivity.
Augmented reality effects: These are effects that overlay digital elements onto the real world, such as filters, stickers, or 3D models. They can create a sense of immersion, fun, or personalization.

The contextual information in media content has a big impact on the selected visual effect to provide more visually appealing and stimulating content. Media content type, the genre of the media content (e.g., scene) or media content item, its social context, cultural context, historical context, political context, educational context, or environment information, such as weather conditions, in the scene can all be factors that impact the selection of the visual effect.

For example, considering genre specifically, a visual effect of rain being applied to an indoor scene would be jarring to a user and reduce the immersion and investment a user has to the media content. Matching genre to the visual effect is one example of the improvement of the present disclosure.

In some examples, for long pauses (e.g., at least 2× the average user pause time) a visual effect to make characters slowly age could be applied. In this way, the visual effect is in of itself contextual and related to the media content. Similarly, in some examples, during a pause event a visual effect could comprise replacing the frame of the character at pause with a frame of the same character in later season or later part of the media content.

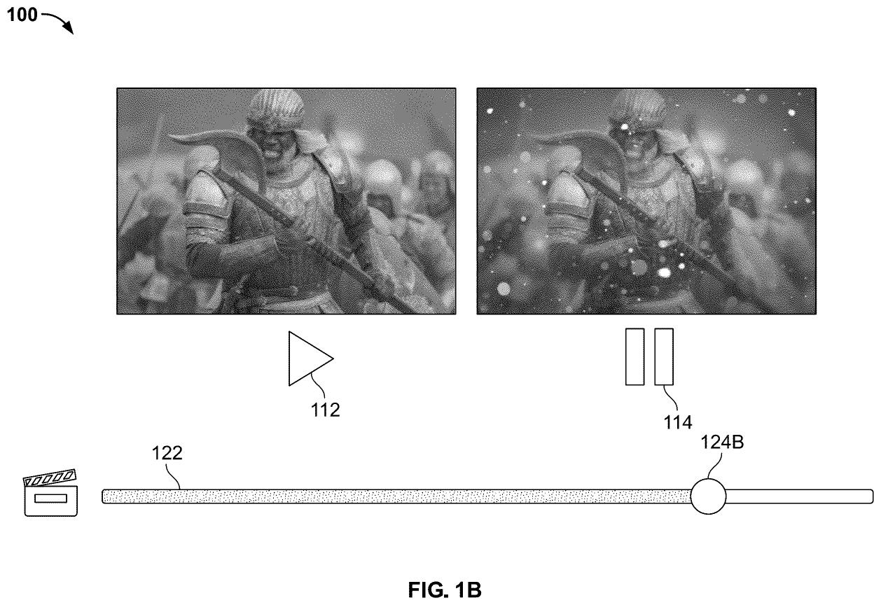

FIG. 2 illustrates a table comprising visual effects that can be applied to media content during a pause event, in accordance with embodiments of the disclosure. Shown is a table 200 representing examples of the different visual effects 212, that can be applied to media content item 100 based on the context information 214 of the paused media content at a particular time.

There are countless genres and visual effects that can be applied to media content. However, some examples of genres include: action, adventure, comedy, drama, fantasy, horror, musicals, mystery, romance, science fiction, sports, thriller, western, animation, documentary, television, crime, biography, indie film, short film, period, history, or Bollywood. In addition to the above listed visual effects, others include: a blur effect; vignette effect; particle effect; depth of field effect; a hue adjustment; a gamma adjustment; brightness adjustment; film grain effect; an audio-visual clip; an interactive poster; a plurality of frames of the media content; a slow-motion effect; a picture-in-picture overlay; or a reconstructed 3D representation of the image data.

As described above with reference to FIGS. 1A and 1B choosing appropriate visual effects based on the contextual information in a scene (or its metadata) can have a great impact on the user's enjoyment of the media content. The media content may comprise metadata, such contextual information can be flagged (220A-C) to the system so that a correct visual effect is added to the media content when it is paused at that point. The contextual information received in the metadata of media content (e.g., scene) or media content item can be monitored so that the system is able to apply effects immediately.

The metadata can be communicated to the system through existing means, such as manifest files of an adaptive bitrate technology. In another example, the contextual information can be identified by the system itself by obtaining image data (i.e., a screenshot of the scene) and applying content recognition techniques to the image to obtain the contextual information.

Once the contextual information is available, appropriate visual effects can be applied. Table 200 is providing a visual aid, however, in some examples, a look-up table can be used by the system to select preconfigured visual effects given the contextual information. Shown in FIG. 2 are seven potential contextual scenes (winter, action, talk show, celebration, reality, sports, and rain) each having an index (1-7) in the table.

As the user progresses through the media content, the progress bar 122 advances as shown by position indicator 124B. A plurality of flags (220A-C) are provided in the metadata of the content item and shown in FIG. 2 as a visual aid. If the user was to pause at a point with metadata at a position represented by flag 220A, this has an index of “1” and therefore is a winter scene. The system would then apply the corresponding visual effect from, for example, a look-up table, such as that shown in FIG. 2. As such, in FIG. 1A the effects that have been applied that correspond to a winter scene are; fog, vignette, snow particles, and bokeh.

In FIG. 2, the progress bar 122 reflects the position of media content item 100 as shown in FIG. 1B. As the user has paused as this position, as shown by position indicator 124B, the flag in this portion of the media content refers to index “2” which corresponds to an action scene. As such, the effects shown in FIG. 1B have been applied; blur, vignette, dust particles, and bokeh.

In addition, the user may have a user-preferred effect, as indicated by favorite icon 230. These effects, as they are user-preferred, may be stored locally, customized by the user, or used for every visual effect. This may also be indicated to the system, such as with a favorite icon 230, or by metadata.

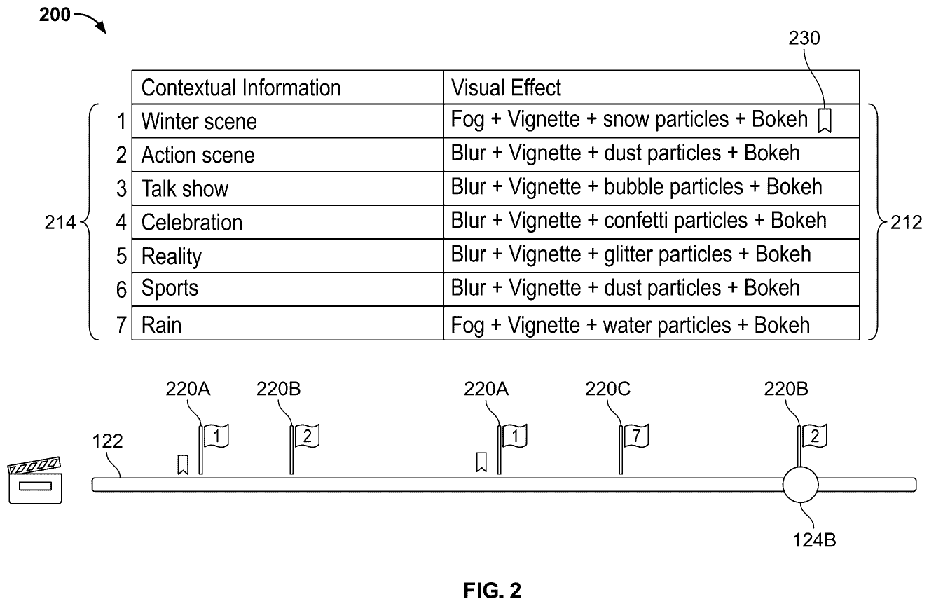

FIG. 3 is a pictorial representation of variable bitrate media content, in accordance with some embodiments of the disclosure. A first bitrate variant 302, a second bitrate variant 304, and a third bitrate variant 306 are shown as 2 Mbit/s (2 megabits per second), 4 Mbit/s, and 8 Mbit/s, respectively. However, it should be understood that any suitable value of bitrates may be used and there may be more or fewer bitrate variants available for any content (e.g., values greater than 8 Mbit/s). In addition, there may also be intermediate bitrate values (e.g., 3.5 Mbit/s).

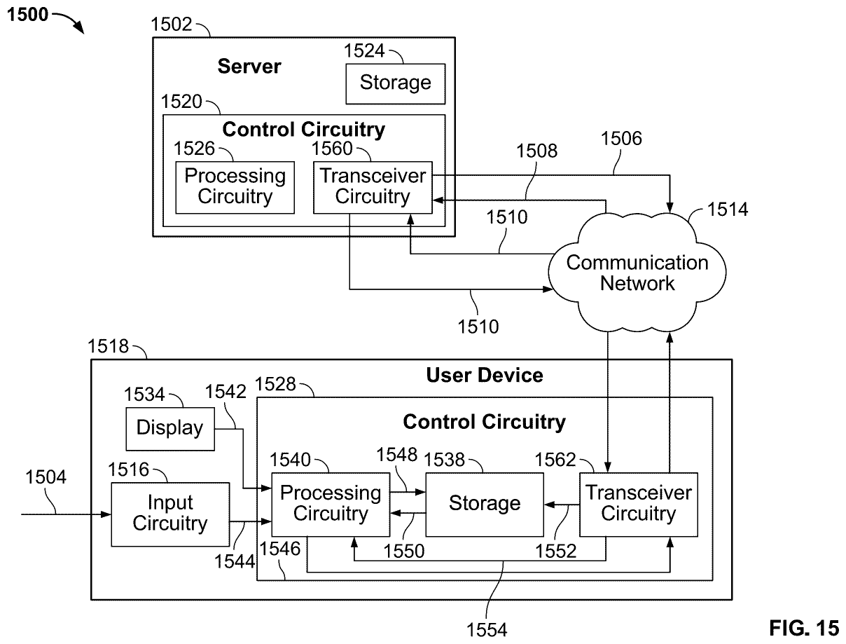

In some examples, the Media Server 1502 (also shown in FIG. 15) separates the first bitrate variant 302, second bitrate variant 304, and third bitrate variant 306 into a plurality of segments 312. In some examples, the segment size is determined by the seconds of content to be consumed. However, in other examples, the segment size can be determined by a number of frames, the cache size of the user device, the length of a segment (in seconds), or the amount of data to be transmitted (i.e., a segment size limit). The plurality of segments 312 are encoded with resolutions ranging from, for example, 360p to 2160p and various quality levels using adaptive bitrate streaming compatible codecs and resolutions for adaptive video streaming formats. In some examples, the lowest bitrate variants are text, hyperlinked text, or a still image. In some examples, the highest bitrate variants are large video formats and high-quality audio. In some examples, each of the bitrate variants is separated by a minimum delta megabit per second (Mbps), for example, 1 Mbps or 2 Mbps.

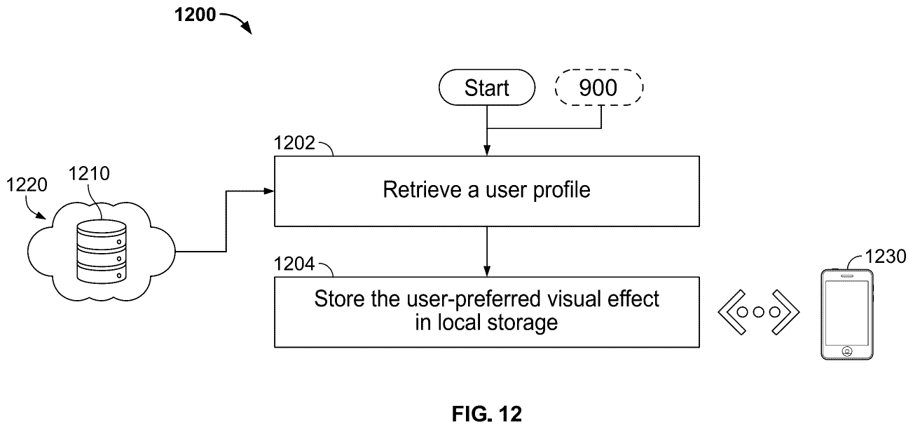

In some examples, a master playlist 314 containing URLs to each of the plurality of segments 312 is outputted and transmitted from the media server 1502 to the user device 1230 (also shown in FIG. 12) as a manifest that describes the available stream segments of an adaptive video stream and their respective bitrate variants to a user device 1230. Which bitrate variant the user device chooses can be changed from second to second or segment to segment. For example, if a user's available bandwidth changes, the user device 1230 can select a different bitrate variant (i.e., a different video quality) to match the available bandwidth.

In some examples, the media server 1502 may determine the complexity of the segment, a plurality of segments (e.g., a plurality of media content items), a number of frames, or an amount of data to be transmitted (e.g., a segment size). In some examples, when the media server 1502 outputs the master playlist 314, such as a manifest, the media server can create an indication of the complexity of each of the segments, scenes, media content items, or frames. In some examples, the present disclosure proposes adding into the header or other segments of the manifest file represented by master playlist 314 metadata related to the contextual information for each of the plurality of segments 312.

In some examples, the segments as described with reference to FIG. 3 are segments of a plurality of segments of an adaptive bitrate stream (e.g., MPEG-DASH, Adobe HTTP Dynamic Streaming, Apple HTTP Live Streaming, Microsoft Smooth Streaming, QuavStreams Adaptive Streaming over HTTP, upLynk, or the like).

In some examples, the bandwidth available to user device 1230 falls between two bitrate variants. For example, if the user device has an available bandwidth of 6 Mbit/s, this would fall between the recommend minimum bandwidth requirement for second bitrate variant 304 and third bitrate variant 306. Therefore, in such situations, it would be desirable to request some segments of the adaptive bitrate stream at the third bitrate variant 306 and some segments at the second bitrate variant 304, in such a way that the average bandwidth required is 6 Mbit/s or less (the maximum available at the user device 1230).

The frequency of media content being paused can vary greatly depending on the context. For example, in the context of web development, the HTMLMediaElement.paused property can be used to determine whether a media element is paused at any given moment. During personal use, individuals might choose to take a break from media content (i.e., a TV show, movie, or social media) for various reasons, as mentioned above. The pause event is sent when a request to pause an activity is handled and the activity has entered its paused state, most commonly after the media has been paused through a call to the element's pause ( ) method. During a pause event, a tag in the manifest file 314 can be identified and data regarding the URL for the visual effect, or simply the context, can be used to apply a visual effect to the media content.

In addition, during the pause event, later segments of the manifest file 314 can be downloaded in a higher quality, if the user's bandwidth allows. In this way, segments can be continued to be stored in cache in parallel to displaying a visual effect.

In some examples, media server 1502 is hosted in the cloud. However, in some examples, the media server 1502 may be a physical edge server of a content delivery network hosted in a data center, the user's home, or the like. The media server 1502 is communicatively coupled to user device 1320 via a communication link 330. In some examples, media content stored on media server 1502, is compatible with known adaptive bitrate stream technologies (e.g., MPEG-DASH, Adobe HTTP Dynamic Streaming, Apple HTTP Live Streaming, Microsoft Smooth Streaming, QuavStreams Adaptive Streaming over HTTP, upLynk, or the like).

The media server 1502, provides the content stored thereon to a plurality of users. User devices, such as user device 1230, that support adaptive bitrate streaming (e.g., DASH or HLS), need to monitor the available bandwidth to determine at what bitrate to request segments (e.g., a media content item) of the requested media content from the media server 1230. In conventional systems, it is just the bandwidth that influences the determination of what bitrate to request.

Additional visual effects could be user-generated content (UGC) by a plurality of other users, related to the media content, such as fan art, or the like. This UGC, could be represented by segments 312 in the media content stored on media server 1502. In addition, behind-the-scenes or exclusive content gives users a teaser or glimpse of how the media content is created or what's coming next, this content could also be represented by segment 312; and utilized, for example, as a teaser frame. All of the visual effects help create curiosity, excitement, and anticipation for the media content, and drive users to return to the media content.

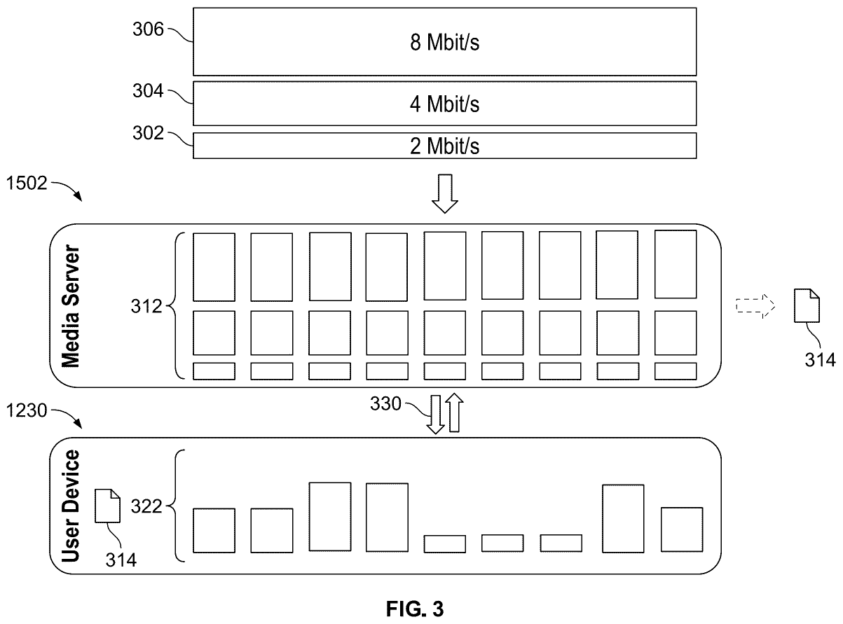

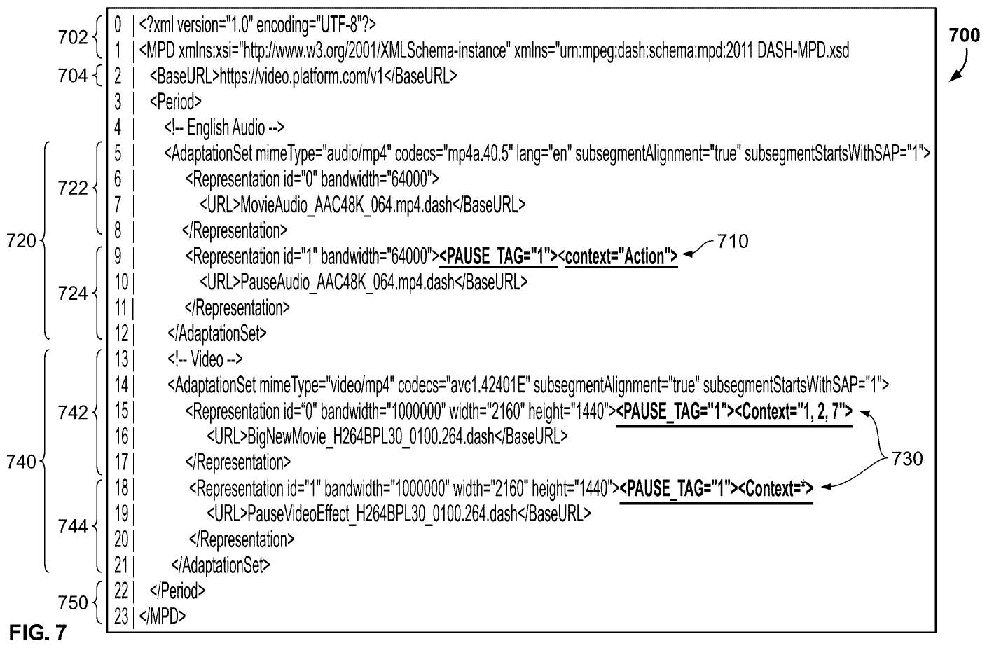

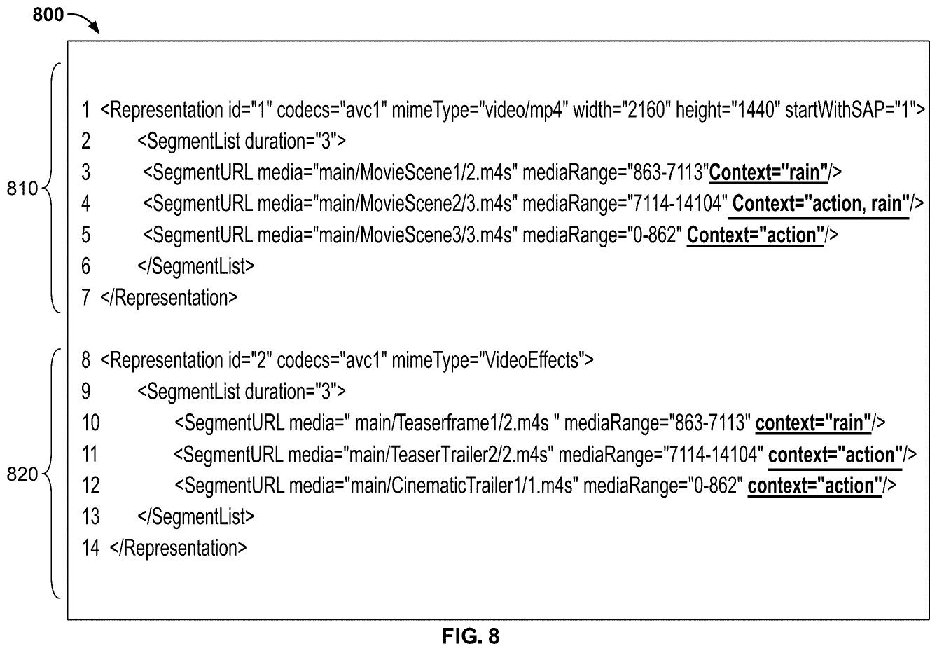

As shown in FIG. 4, a request 400 contains a request URL 402. The request URL 402 may have been obtained from a master playlist or the like, such as that described below with reference to FIGS. 7 and 8. The request URL 402 may also contain some header information, that identifies request 400 as a request. In some examples, the request URL 402 is for a specific bitrate variant of a media content item, wherein the user device 1320 is already aware of the complexity of the segment. For example, the manifest or master playlist 314 from the media server 1502 not only provides the request URLs 402 for a segment but also comprises an indication of the complexity (detail) of the segments.

In some examples, the request 400 contains a request method 404, which may be any one or more of a GET, PUT, POST, HEAD request method 404, for example. GET, PUT, POST, HEAD, as well as others such as DELETE, CONNET, OPTIONS, TRACE, and PATCH, are a set of request methods known in the HTTP standard to indicate the desired actions to be performed for a given resource, these and others are considered examples of the request method 404 blocks of request 400. Each of the request methods implements a different semantic, but some common features are shared by a group of them: e.g., a request method can safe, idempotent, or cacheable. The GET method requests a representation of the specified resource, whereas the HEAD method asks for a response similar to that of a GET request without the response body. All of the request methods as discussed above may be adapted to include methods of the present disclosure. For example, the GET request may be modified to include a request for a specific complexity type.

In some examples, request 400 may also include a contextual information 406 request, which indicates a request for the contextual information for each of the segments of the request 400. The contextual information request 406 can utilize many known codes in the HTTP standard from 100 (continue) to 404 (not found) and the like. In this way, the user device can communicate effectively with the server without significant adaptation needed. For example, to have a server check the request's headers, a client must send “Expect: 100-continue” as a header in its initial request and receive a 100 continue status code in response before sending the body. In some examples, the request 400 may also comprise a plurality of other meta-data, such as, for example, remote address, referrer-policy information, time stamps, request length, segment identifiers, media content identifiers, server identifier information, pause tags, and the like.

In some examples, request 400 may also include a pause tag 408, which indicates the request wants to know the context during a pause event that the user device 1230 is seeking. However, in alternative examples, the user device 1230 can identify the contextual information using content recognition techniques. In the latter case, request 400 may simply comprise “context: 100 (continue)” indicating that the context will be identified locally. In this way, request 400 is backwards compatible with servers without the ability to provide contextual information in the metadata of the manifest file 314.

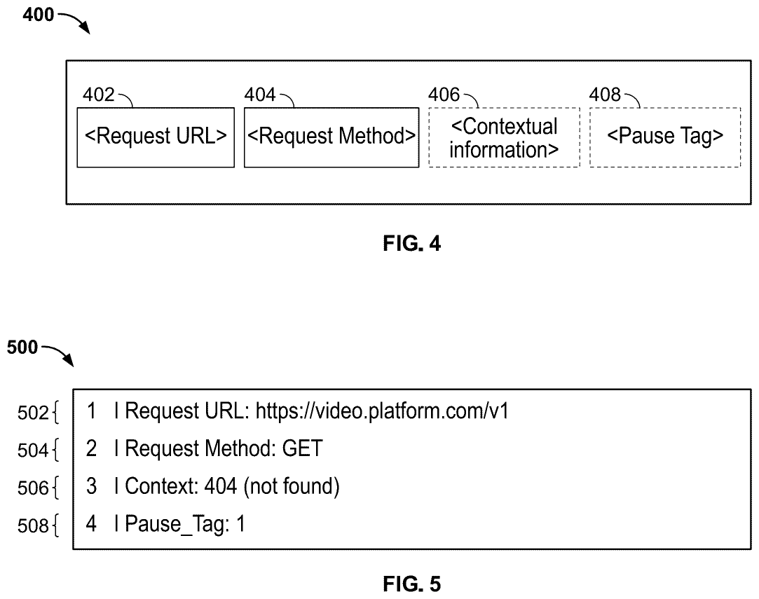

FIG. 5 illustrates an exemplary pseudo-code for an adaptive bitrate request, in accordance with some embodiments of the disclosure. FIG. 5 is considered to be an exemplary implementation of request 400 as described above with reference to FIG. 4. In request 500 there is provided a request URL 502, a request method 504, a context indicator 506, and a pause tag 508.

Request 500 comprises a request URL 502 in line 1. The request URL 502 is shown as “Request URL: https://video.platform.com/v1”, this should be understood to be an exemplary way of indicating request URL 502 and is intended to be non-limiting. In this example, the URL for the requested content was retrieved from a master playlist 314 or manifest of a dynamic adaptive streaming over HTTP (DASH), also known as MPEG-DASH. In line 2, the request method 504 is shown to be a GET request, and the current context information of request 500 is shown in line 3, by context information tag 506, which shows status code 404 (not found).

In some examples, request 500 may also include a pause tag 508, such as that shown on line 4, which indicates that the request is comprising media content to be provided to the user during a pause event. The pause tag is shown as “1” indicating that URLs to the visual effects are also required. However, in some examples, this is not necessary as the user device 1230 can have visual effects stored locally.

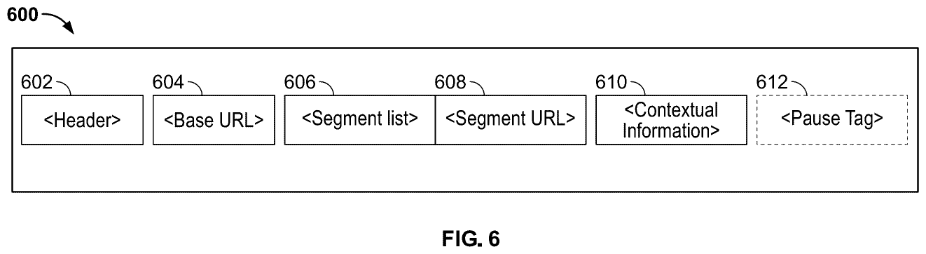

FIG. 6 is a pictorial representation of a manifest for adaptive bitrate content, in accordance with some embodiments of the disclosure. In an exemplary manifest 600, there is provided a header 602, base URL 604, segment list 606, segment URL 608, and contextual information 610, and, optionally, a pause tag 612.

The manifest 600 is a container file for chunks of data that provide a user device with the information required for the user device to request a video or audio resource (e.g., media content or a media content item). As shown in FIG. 6, a manifest 600 starts with a header 602 and then contains a series of data blocks 602 to 612. In some examples, the header of the manifest identifies the format that the manifest is in (e.g., HTML, XML, or the like) and/or what adaptive bitrate technology the manifest relates to (e.g., DASH, HLS, or the like). In some examples, the header can be omitted from being present within manifest 600 because the format of the manifest 600 can be indicated by the filename extension suffix (e.g., “.xml,” “.m3u8,” “.txt,” or the like), or a footer (not shown in FIG. 6, but included in the exemplary pseudo-code shown in FIGS. 7 and 8).

In some examples, the data blocks of a manifest may comprise a block indicating a base URL 604, a Segment list 606, a segment URL 608, contextual information 610, and a pause tag 612. Other examples of data blocks include media type, representation blocks, ID tags, file names, initialization source, subtitles, and fallback sources (e.g., failover URLs).

In some examples, a data block may be a base URL 604 for signaling the base URL that all resources to follow will be obtained from. For example, the base URL 604 is the first part of a website URL such as “http://video.platform.com/v1.” It is this base URL that later described segment URLs will be concatenated onto. Like any of the data blocks 604 to 612, the Base URL 604 may comprise any text or character with an equivalent Unicode Code Point. In some examples, Base URL 604 may be unique to the whole manifest that all subsequent URLs, such as Segment URL 608, are concatenated onto.

In some examples, a data block may be a segment list 606. In some examples, Segment list 606 may further comprise a segment reference, for example, a range of frames to obtain (e.g., range=“0-862”), a start and end time to obtain (e.g., 1253s to 1258s), or a segment reference ID (e.g., “segment 12”). In some examples, the segment list 606 further comprises a bitrate variant reference ID or tag. In some examples, the segment list 606 with a range of frames to obtain is referred to as a media range. In some examples, there may be a minimum duration that the segment list 606 indicates. For example, a minimum duration of 10 seconds to obtain as a segment, although any period may be chosen as a minimum duration.

In some examples, a data block may be a segment URL 608. As mentioned briefly above, segment URL 608 is a suffix to be added to the base URL by the user device to complete the URL to a particular segment. In other words, base URL 604 and segment URL 608 together make the complete URL to any particular media content item contained within the manifest. In some examples, the whole URL per segment or bitrate variant is displayed in the segment list 606; however, this is often unnecessarily clogging up the manifest with a lot of repetitive data. In the concatenating examples, the overall manifest file size is kept to a minimum, reducing unnecessary overheads in the manifest file.

The manifest 600, may further comprise a data block that represents contextual information 610. In some examples, the contextual information block 610 is used to provide context to the scene being indicated in the URL. The contextual information 610 may be a contextual tag that the logic of the user device can interpret. The contextual information may represent media content type, genre, social context, cultural context, historical context, political context, educational context, or environmental data. Additional segment metadata may also be included, for example, codecs, audio tag, video tag, version numbers, encoding information, bandwidth markers, resolution or size of media content, or file names. The start time, end time, and segment reference as discussed with reference to segment list 606 are considered an example of meta-data of the segment list 606 data block, for example.

In some examples, the contextual block 610 is configurable by the user or is configured by a user profile of the user, which can be obtained by control circuitry. For example, a user profile linked to the user device may configure the contextual tag to always select their favorite visual effect when available. In some examples, contextual information block 610 may further comprise rules on waiting periods for a fetch before applying a visual effect locally, in essence acting when the fetch time is greater than the expected download time.

Any data blocks 602 to 612 which are not understood by legacy media asset players, due to the fact they have not been updated to read such data blocks, would be ignored. Therefore, in some examples, the manifest 600 is backward compatible with legacy user devices. Data blocks 602 to 612 may be separated by lines, commas, semi-colons, special characters, or any other common choices of the syntax used in computing languages such as C++, C#, Python, R, Java, JavaScript, HTML, and the like.

In some examples, the user device 1230 can do an initial parse of the manifest to determine the signaled encoding complexity of the segments (e.g., in the case where the user is streaming a video-on-demand content item). The user device 1230 can initially ignore the indication of contextual blocks 610 until after the steaming session has started and a healthy buffer has been maintained. The user device 1230 can also signal to the media server 1502 that it intends to fetch a group of consecutive segments at a specific bitrate (e.g., the highest bitrate possible according to the available bandwidth at the user device 1230), and visual effects of a certain complexity, instead of making separate HTTP GET requests for each. Such an indication can also allow the media server 1502, or an edge server, to make these segments or visual effects available (if not already cached). In such a case, the media server's 1502 response is the requested segments as separate segments or one video file containing the aggregate of those segments.

FIGS. 7 and 8 illustrate exemplary pseudo-code for flagging uniform resource locators when there is and is not a pause event, and metadata in the form of contextual information, in accordance with some embodiments of the disclosure. FIGS. 7 and 8 are example implementations of manifest 600 as described above with reference to FIG. 6.

FIG. 7 shows a manifest 700. In manifest 700 there is provided a header 702, a base URL 704, first contextual information 710, a first segment list 720, comprising first and second segment URLS 722 and 724, second contextual information 730, a second segment list 740, comprising first and second segment URLs 742 and 744, a footer 750.

The manifest 700 is a container file, usually comprising lines of instructions to be carried out by a user device. The manifest 700 may be generated by a media server in response to a request to deliver media content, such as media server 1502. In particular, manifest 700 starts with a header 702 comprising lines 0 and 1 of the pseudo-code. In this example, the header informs the user device of the version and encoding formats of the manifest 700 and includes some reference sources for information. The user device may be a web browser, media player, application on a smartphone, or another device.

The manifest 700 comprises a base URL 704 in line 2. The base URL 704 is “http://video.platform.com/v1” and is shown between two tags, indicating the base URL 704 to the user device.

Lines 4 and 12 comprise a first segment list 720, comprising first and second segment URLs 722 and 724. The first segment list 720 comprises the audio for the media content. The first contextual information 710, shown on line 9 of FIG. 7, comprises a contextual information tag and pause tag that indicates that the corresponding line is the audio file that should be played on a pause event and that the audio is has the context “action”. Providing context to the audio at least gives the user device 1230 some context information in the event that the video segments (discussed below), which are typically larger files, are not obtained. The second contextual information 730, shown on lines 15 and 18, comprises a contextual tag that indicates the corresponding lines comprise the context shown. For example, line 15 refers to index 1, 2, and 7 on a look-up table of visual effect information relating to the media content. The user device can therefore identify the lines following the first and second contextual information 710 and 730 as such.

Manifest 700 comprises a first segment list 720. First segment list 720 comprises the first contextual information 710 on line 4, as discussed above, and therefore the user device 1230 will understand that the first segment list 720 is a segment list for audio and comprises the context “action”, in particular, lines 5 to 11 of manifest 700 provide the information required for the user device to obtain the audio contained within the base URL 704. In some examples, the user device concatenates the base URL 704 with the segment URL found within the first and second segment lists 720 and 740 to obtain the full URL where the media content item can be found.

Manifest 700 comprises a second segment list 740, comprising first and second segment URLs 742 and 744. The media content item that manifests 700 comprises the URLs for the user device to obtain comprises multiple bitrate variants. In particular, a bitrate variant is contained within the first segment URL 742 requiring a bandwidth of 1 Mbit/s (megabits per second) that has a resolution of 2160×1440, as shown in FIG. 7 in the metadata of lines 15 to 17. A second bitrate variant is contained within the second segment URL 742 requiring a bandwidth minimum of 2 Mbit/s that has a resolution of 3840×2160 as shown in FIG. 7 in the metadata of lines 18 to 20. The first and second segment URLs 742 and 744 point to a video titled “BigNewMovie” encoded with advanced video coding (AVC) also referred to as H.264 or MPEG-4 Part 10, Advanced Video Coding (MPEG-4 AVC).

The contextual information tag on line 15 comprises just the look-up index, as this segment URL relates to a lower bandwidth, the user device can instead look up an associated visual effect rather than seek a URL for any particular visual effects for a given scene. Manifest 700 shows that some contextual information may be provided for a media content as a whole. However, in the example to be discussed with regard to FIG. 8, it is preferable that the contextual information is provided on a scene-by-scene basis such that the most appropriate visual effect is determined and applied to the media content at all times.

Manifest 700 comprises a footer 750. The footer indicates the end of the manifest 700 and often comprises contextual information such as file extension suffixes (e.g., “.xml,” “.m3u8,” “.txt,” or the like). Further information may also be included in the manifest 700 files such as initialization sources, subtitles, and fallback sources (e.g., failover URLs).

Lines 9, 15, and 18 of manifest 700 comprise an indication of contextual information and pause tags, shown as in-line tags. These may be provided, however, on separate lines. In the current example, in-line tags are useful to choose as they can be ignored by legacy media players, and still continue through the lines in manifest 700, in the event that they are not updated with the ability to interpret contextual information and pause tags. The contextual information may comprise words or a numeric value that user devices can interpret with logic to infer context information in a look-up table. In particular, the numeric values shown in FIG. 7 on line 15 corresponds to the entries in table 200 of FIG. 2, such that index values 1, 2, and 7 relate to a winter scene, action scene, and rain respectively. Alternatively, as shown in line 18, contextual information can be further sought per scene, and this can be indicated by a contextual information tag “*”, indicating that contextual information is provided per segment, as shown with regard to FIG. 8.

It should be understood that this example is intended to be non-limiting and numerous other examples of indicating the tag are possible. In some examples, the user device will search through the manifest 700 to find parts of the manifest 700 of interest indicated by the presence of pause tags and contextual information tags or line entries.

FIG. 8 shows part of a manifest 800 comprising a first segment list 810 and a second segment list 820. The first and segment lists 810 and 820 of manifest 800 are different examples of the first and second segment lists 720 and 740 of manifest 700, as described with reference to FIG. 7 above. In particular, FIG. 8 illustrates a different way of implementing the indication of contextual in manifest 800 compared to manifest 700 of FIG. 7. For example, and as will be discussed in more detail below, FIG. 8 illustrates tagging each segment URL within the manifest 800 with contextual information.

In FIG. 8, the contextual information is shown for each segment within the first and second segment lists 810 and 820. For example, context=“rain” is shown on line 3, to indicate that the segment contained within the associated segment URL requires the visual effect rain particles to be displayed should the user pause during this segment. Each of the segment URLs on lines 3 to 5 is shown with a context information tag. In this way, the user device has an indication of the context for each segment of a plurality of segments and allows greater granularity when a user may pause the media content at such segments. With the context per scene, or plurality of frames, the user device 1230 can implement appropriate corresponding effects as described herein.

In some examples, lines 10-12 may be present in the manifest 800, which are specific visual effects that can downloaded by the user device 1230 and stored in local cache, to be applied at the appropriate pause place. The visual effects are provided with their context such that the user device 1230 can cross reference the context of a segment, such as those in lines 3-5 and apply those visual effects that a segment calls for when a pause event by the user of the media content occurs. However, as described herein, in some examples, the contextual information can be determined by user device 1230.

FIG. 9 illustrates an exemplary flowchart of the processing involved in displaying media content with a visual effect, in accordance with embodiments of the disclosure. This process can be carried out by control circuitry or processing circuitry on the user device 1230. Process 900 starts at step 902, wherein contextual information of the media content at the pause event is determine. In some examples, the determination is made after a request for such information from a user device 1230, e.g., a media transmission device, to a media server 1502, e.g., an OTT platform or node in a content delivery network. In some examples, the determination is made by content recognition of the media content during the pause event.

At step 904, a visual effect based at least in part on the contextual information is determined. For example, the media server 1502 may provide, in a manifest or master playlist, an indication of the visual effect associated with the contextual information of a segment, scene, frame, or media content item. The indication of context may be alphanumerical or any other symbol that the user device 1230 can interpret as an indication of context. As such, a visual effect associated with the contextual information is selected or determined. The visual effect may be downloaded via the media server 1502 by the user device 123, by retrieving the visual effect from local storage/cache from the user device 1230, or by generating the effect by using the computer processing unit (CPU) or graphics processing unit (GPU) of the user device 1230.

At step 906, the media content based on the visual effect is modified. At step 908, the modified media content is displayed to a user during the pause event.

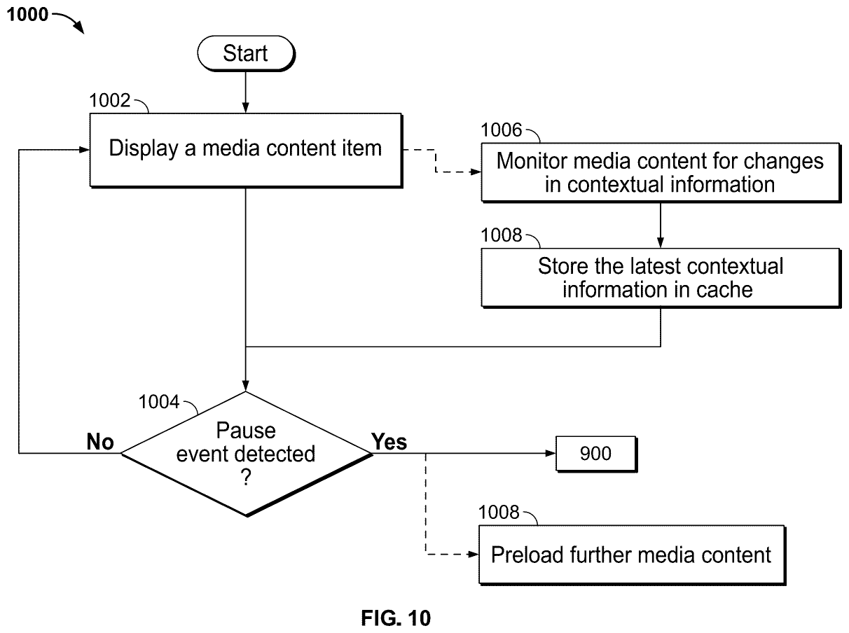

FIG. 10 illustrates an exemplary flowchart of the processing involved in detecting a pause event and monitoring steps prior to a pause event, in accordance with embodiments of the disclosure. This process can be carried out by control circuitry or processing circuitry on the user device 1230. Process 1000 starts at step 1002, wherein a media content item or media content is displayed to a user.

At step 1004, it is determined if a pause event is detected. If the answer to step 1004 is no, process 1000 reverts back to step 1002. If the answer to step 1004 is yes, process 1000 continues on to process 900, as described above with reference to FIG. 9.

Optionally, process 1000 carries out step 1006. Step 1006 can be carried out while process 1000 is in the loop between step 1002 and 1004. At step 1006, the media content is monitored for changes in the contextual information of the media content. For example, while the user watches media content 100, the system be detect via content recognition or from the manifest of the media content, such as manifest 700 of FIG. 7, that the contextual information of the current segment has changed. If the contextual information of the media content changes, process 1000 continues on to step 1008. At step 1008, the latest contextual information is stored locally, on the user device 1230, in cache.

Optionally, process 1000 carries out step 1008. Step 1008 can be carried out if the answer to step 1004 is yes. In some examples, 1008 is carried out in parallel to process 900 of FIG. 9. At step 1008, further media content is preloaded, and stored locally, on the user device 1230, in cache. In some examples, at step 1008, further media content is prefetched, and stored locally, on the user device 1230, in cache.

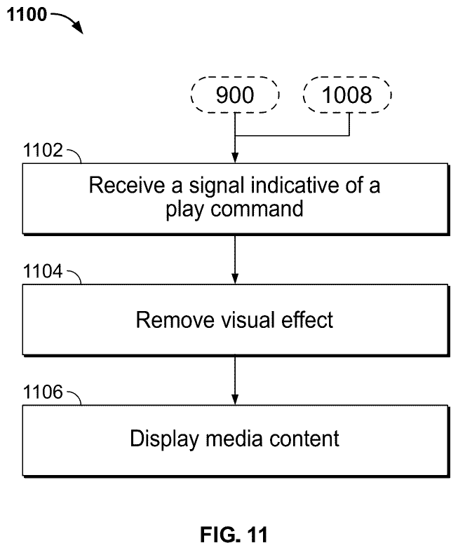

FIG. 11 illustrates an exemplary flowchart of the processing involved in removing a visual effect, in accordance with embodiments of the disclosure. This process can be carried out by control circuitry or processing circuitry on the user device 1230. Process 1100 begins after or during process 900 of FIG. 9, or after step 1008 of Process 1000 of FIG. 10. Process 1100 starts at step 1102. At step 1102, a signal indicated of a play command is received at user device 1230 from a user.

At step 1104, the visual effect applied to the media content, resulting in the modified media content, is removed. In some examples, this can be removed by reversing by processing circuitry the effects applied to the media content item, or by deleting the modified content item and retrieving the original media content. At step 1106, the original media content (that is the unmodified media content) is displayed to the user and they can continue watching the media content from the pause event position of the media content.

FIG. 12 illustrates an exemplary flowchart of the processing involved in retrieving user-preferred visual effects, in accordance with embodiments of the disclosure. This process can be carried out by control circuitry or processing circuitry on the user device 1230. Process 1200 can be carried out in parallel to any of the other processes described herein, for example, process 900 of FIG. 9. Process 1200 starts at step 1202.

At step 1202, a user profile is retrieved. The user profile may be retrieved by the user device 1230, from a server 1210 hosted in the cloud 1220. The user profile contains within it an indication of user preferences. Such user preferences comprise, for example, a user-preferred visual effect, user data, such as watch history and the like. At step 1204, the user-preferred visual effect is stored in local storage at the user device 1230. Alternatively, an indication of the user-preferred visual effect is stored in local storage, and the effects are rendered locally by the user device 1230 according to the indication of the user-preferred visual effect.

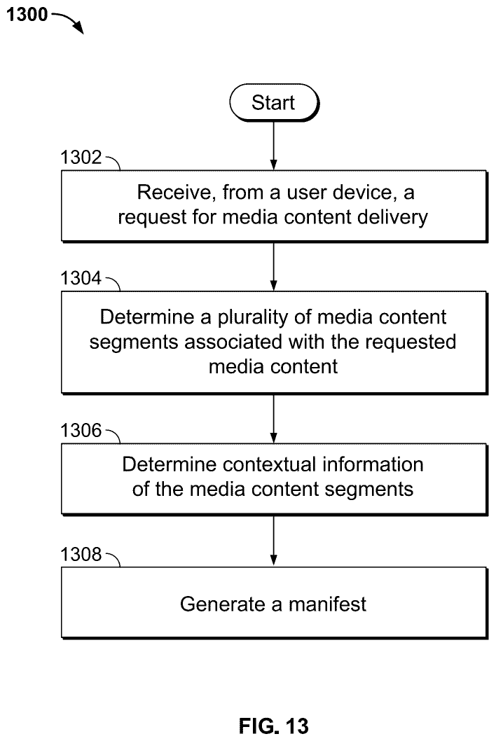

FIG. 13 illustrates an exemplary flowchart of the processing involved in generating a manifest for adaptive bitrate media content, in accordance with embodiments of the disclosure.

Process 1300 begins at step 1302. At step 1302, a request for media content delivery is received from a user device, such as user device 1230 at a media server, such as server 1502.

At step 1304, a plurality of media content segments associated with the requested media content are determined. At step 1306 contextual information of the media content segments is determined.

At step 1308 a manifest is generated. In some examples, the manifest comprises a plurality of uniform resource locators, URLs, indicating the location of the media content segments. In some examples, the manifest further comprises indications of contextual information associated with each media content segment, wherein the contextual information is associated with a visual effect to be applied to each media content segment during a pause event of the media content.

In some examples, the manifest further comprises instructions on how to modify the media content based on the visual effects.

In some examples, during the pause event, the media server 1502, receives a request for further media content delivery; and process 1300 may further include such a step. In some examples, the further media content is a further plurality of media content segments associated with the requested media content. In some examples, the further media content is visual effects associated with the media content segments in the manifest.

In some examples, generating the manifest further comprises tagging the URLs with the contextual information. In some examples, the request for content delivery comprises an indication to retrieve consecutive segments of the content.

Optionally, process 1300 includes (not shown), in response to the request for content delivery comprising an indication to retrieve consecutive segments of the content, instructions for caching the consecutive segments of the content.

Optionally, process 1300 includes (not shown), receiving a request for a user profile, the user profile is indicative of a user-preferred visual effect; and sending the user profile or an indication of the user-preferred visual effect to the user device.

In some examples, the manifest comprises indications where the user-preferred visual effect can be used during the pause event.

In some examples, the contextual information comprises one or more of: media content type, genre, social context, cultural context, historical context, political context, educational context, or weather data.

In some examples, the genre is at least one of: action, adventure, comedy, drama, fantasy, horror, musicals, mystery, romance, science fiction, sports, thriller, western, animation, documentary, television, crime, biography, indie film, short film, period, history, or Bollywood.

In some examples, the visual effect comprises one or more of: a blur effect; vignette effect; particle effect; depth of field effect; a hue adjustment; a gamma adjustment; brightness adjustment; film grain effect; an audio-visual clip; an interactive poster; a plurality of frames of the media content; a slow-motion effect; a picture-in-picture overlay; or a reconstructed 3D representation of the image data. In some examples, the visual effect comprises a teaser frame of the media content.

In some examples, the teaser frame is selected from the plurality of media content segments.

The described method for generating a manifest for adaptive bitrate media serves the purpose of efficiently delivering media content to a user device while also providing contextual information for the associated media content segments. In particular, by determining a plurality of media content segments and their respective URLs, the method facilitates the efficient retrieval of media content. This enables adaptive bitrate streaming, where the user device can request and receive different quality versions of the content based on its available bandwidth and device capabilities.

In addition, the method goes beyond providing URLs for media segments. It also determines and includes contextual information for each segment. This contextual information is associated with visual effects to be applied during a pause event. This means that when a user pauses the media content, the associated visual effects can be triggered, enhancing the viewing experience.

Moreover, by including contextual information and visual effects in the manifest, the method enhances the user experience during pause events. Instead of a static paused frame, viewers can expect specific visual effects tailored to the content. This adds an additional layer of engagement and immersion.

Furthermore, the contextual information allows for customization of visual effects based on the content. Different media content segments may have unique visual effects associated with them, creating a more tailored and dynamic viewing experience.

In some examples, transmitting the manifest to the user device ensures that the device has the necessary information to retrieve and present the media content effectively. This transmission is a critical step in the adaptive streaming process.

Moreover, the method has an impact on bandwidth optimization: for example, the manifest generation process can also optimize content delivery by selecting appropriate bitrates and resolutions for each segment based on the user device's capabilities and network conditions. This ensures smoother playback and minimizes buffering.

In summary, a technical effect of this method is to provide an adaptive and immersive media content delivery system. It combines efficient content delivery with contextual information and visual effects, ultimately enhancing the user's experience when consuming media content, especially during pause events.

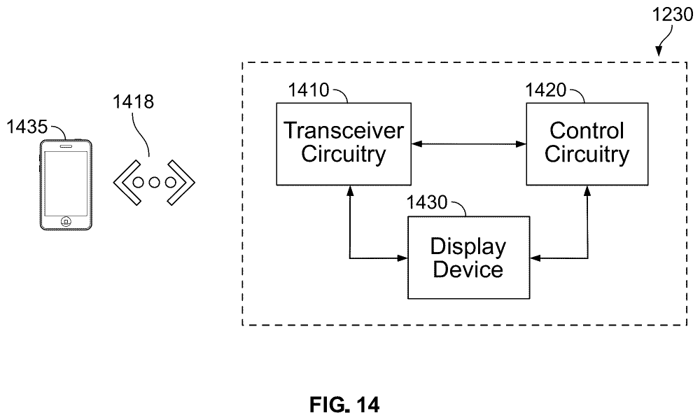

FIG. 14 illustrates an exemplary media transmission device, in accordance with some embodiments of the disclosure. The media transmission system 1230 comprises transceiver circuitry 1410, control circuitry (or processing circuitry) 1420, and a display device 1430. The media transmission system may communicate with an additional user device 1435, such as a home game way, smartphone, or other smart devices. In some examples, the transceiver circuitry 1410 is configured to request, to a media server, media content for delivery, and receive, from the media server, manifest files of an adaptive bitrate technology and download segments of media content via the URLs located in the manifest file. The media content or media content item may be stored on a media content storage, cache, or the like, of user device 1230 (not shown).

In some examples, the control circuitry 1420 is coupled to the transceiver circuitry 1410. In some examples, the control circuitry 1420 is adapted to select or determine, based on the indication of the context of a paused media content item, at least one visual effect to be applied to the media content item. Accordingly, the control circuitry 1420 may display, to a user, the modified media content item.

In some examples, the transceiver circuitry communicates with a second user device 1435 via communication link 1418. The communication link 1418 between the transceiver module 1410 and the second user device 1435 may comprise a physical connection, facilitated by an input port such as a 3.5 mm jack, RCA jack, USB port, ethernet port, or any other suitable connection for communicating over a wired connection or may comprise a wireless connection via BLUETOOTH, Wi-Fi, WiMAX, Zigbee, GSM, UTMS, CDMA, TDMA, 3G, 4G, 4G LTE, 5G or other wireless transmissions as described by the relevant 802.11 wireless communication protocols.

In some examples, the communication link 1418 is between the media transmission device 1400 and a home gateway device, which is in turn in communication with the second user device 1435. In some examples, the home gateway device may transmit a portion of a manifest 400, 500, 600, 700, or 800 to the second user device 1435. For example, the second user device 1435 may receive just the base URL 604 and the segment URL 606 to make the GET request for the media content item. In this way, it would be the home gateway device that would be carrying out the disclosed methods. However, these examples are considered to be non-limiting and other combinations of the features herein being spread over two or more devices are considered within the scope of this disclosure. For example, each of the transceiver module, the network module, and the control module may be separate internet of things (IoT) devices.

FIG. 15 is a block diagram representing devices, components of each device, and data flow therebetween for an adaptive video streaming system, in accordance with some embodiments of the disclosure. System 1500 is shown to include a client device 1518, a server 1502, and a communication network 1514. It is understood that while a single instance of a component may be shown and described relative to FIG. 15, additional instances of the component may be employed. For example, server 1502 may include or may be incorporated in, more than one server. Similarly, communication network 1514 may include or may be incorporated in, more than one communication network. Server 1502 is shown communicatively coupled to client device 1518 through communication network 1514. While not shown in FIG. 15, server 1502 may be directly communicatively coupled to client device 1518, for example, in a system absent or bypassing communication network 1514.

In some examples, the request to stream the media content is made by a user device or a network device. For example, a user device or a network device (e.g., a laptop, PC, smartphone, smart TV, or the like) requests a media server to stream the media content.

In some examples, the media content is an adaptive bitrate stream compatible with the MPEG-DASH standard, or other implementations such as Apple HLS. In some embodiments, the first stream of media content is encoded at a first maximum bitrate and/or the first resolution. For example, the request may be a request for the next segment of an adaptive bitrate stream, and therefore the first stream of media content is at a first maximum bitrate (or resolution) based on the first network bandwidth. In some examples, the second stream of media content is encoded at a second maximum bitrate and/or a second resolution. For example, the request may be a request for the second segment of an adaptive bitrate stream, and therefore the second stream of media content is at a second maximum bitrate (or resolution) based on new current network bandwidth, different from the first network bandwidth. The second stream may be a higher bitrate than the first stream, or vice versa, depending on the network bandwidth at the current time of the request. Accordingly, in some embodiments, each of the alternative streams comprises a plurality of bitrate variants.

In some examples, the media content is encoded using an adaptive bitrate streaming-compatible codec. There are numerous examples of video codecs that are adaptive bitrate streaming compatible (e.g., x264, OpenH264, H.264/MPEG-4 AVC, which are all codecs compatible with the video format H.264). Moreover, there are numerous examples of video formats (e.g., H.264, H.265, VP9, AV1), each of which has numerous examples of video codecs.

Communication network 1514 may comprise one or more network systems, such as, without limitation, an internet, LAN, WIFI, or other network systems suitable for audio processing applications. In some embodiments, system 1500 excludes server 1502, and functionality that would otherwise be implemented by server 1502 is instead implemented by other components of system 1500, such as one or more components of communication network 1514. In still other embodiments, server 1502 works in conjunction with one or more components of communication network 1514 to implement certain functionalities described herein in a distributed or cooperative manner. Similarly, in some embodiments, system 1500 excludes client device 1518, and functionality that would otherwise be implemented by the client device 1518 is instead implemented by other components of system 1500, such as one or more components of communication network 1514 or server 1502 or a combination. In still other embodiments, the client device 1518 works in conjunction with one or more components of communication network 1514 or server 1502 to implement certain functionality described herein in a distributed or cooperative manner.

The client device 1518 includes control circuitry 1528, display 1534, and input-output circuitry 1516. Control circuitry 1528 in turn includes transceiver circuitry 1562, storage 1538, and processing circuitry 1540. In some embodiments, client device 1518 or control circuitry 1528 may be configured as client device 1330 of FIG. 13.

Server 1502 includes control circuitry 1520 and storage 1524. Each of the storages 1524 and 1538 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Each storage 1524, 1538 may be used to store various types of content, media data, and or other types of data (e.g., they can be used to store media content such as audio, video, and advertisement data). The non-volatile memory may also be used (e.g., to launch a boot-up routine and other instructions). Cloud-based storage may be used to supplement storages 1524, 1538 or instead of storages 1524, 1538. In some embodiments, the pre-encoded or encoded media content, in accordance with the present disclosure, may be stored on one or more of storages 1524, 1538.

In some embodiments, control circuitry 1520 and/or 1528 executes instructions for an application stored on the memory (e.g., storage 1524 and/or storage 1538). Specifically, control circuitry 1520 and/or 1528 may be instructed by the application to perform the functions discussed herein. In some implementations, any action performed by control circuitry 1520 and/or 1528 may be based on instructions received from the application. For example, the application may be implemented as software or a set of executable instructions that may be stored on storage 1524 and/or 1538 and executed by control circuitry 1520 and/or 1528. In some embodiments, the application may be a client/server application where only a client application resides on client device 1518, and a server application resides on server 1502.

The application may be implemented using any suitable architecture. For example, it may be a stand-alone application wholly implemented on client device 1518. In such an approach, instructions for the application are stored locally (e.g., in storage 1538), and data for use by the application is downloaded periodically (e.g., from an out-of-band feed, from an internet resource, or using another suitable approach). Control circuitry 1528 may retrieve instructions for the application from storage 1538 and process the instructions to perform the functionality described herein. Based on the processed instructions, control circuitry 1528 may determine a type of action to perform in response to input received from the input/output path (or input-output circuitry) 1516 or the communication network 1514. For example, in response to a network bandwidth maximum, control circuitry 1528 may perform the steps of processes relative to various embodiments discussed herein.

In client/server-based embodiments, control circuitry 1528 may include communication circuitry suitable for communicating with an application server (e.g., server 1502) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 1514). In another example of a client/server-based application, control circuitry 1528 runs a web browser that interprets web pages provided by a remote server (e.g., server 1502). For example, the remote server may store the instructions for the application in a storage device. The remote server may process the stored instructions using circuitry (e.g., control circuitry 1528) and/or generate displays. Client device 1518 may receive the displays generated by the remote server and may display the content of the displays locally via display 1534. This way, the processing of the instructions is performed remotely (e.g., by server 1502) while the resulting displays, such as the display windows described elsewhere herein, are provided locally on the client device 1518. Client device 1518 may receive inputs from the user via input circuitry 1516 and transmit those inputs to the remote server for processing and generating the corresponding displays. Alternatively, client device 1518 may receive inputs from the user via input circuitry 1516 and process and display the received inputs locally, by control circuitry 1528 and display 1534, respectively.

Server 1502 and client device 1518 may transmit and receive content and data such as media content via communication network 1514. For example, server 1502 may be a media content provider, and client device 1518 may be a smart television configured to download or stream media content, such as a YouTube video, from server 1502. Control circuitry 1520, 1528 may send and receive commands, requests, and other suitable data through communication network 1514 using transceiver circuitry 1560, 1562, respectively. Control circuitry 1520, 1528 may communicate directly with each other using transceiver circuitry 1560, 1562, respectively, avoiding communication network 1514.

It is understood that client device 1518 is not limited to the embodiments and methods shown and described herein. In non-limiting examples, the client device 1518 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, client equipment, or wireless device, and/or combination of the same capable of suitably displaying and manipulating media content.

Control circuitry 1520 and/or 1518 may be based on any suitable processing circuitry such as processing circuitry 1526 and/or 1540, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 1520 and/or control circuitry 1518 are configured to implement a media content operation system, such as systems, or parts thereof, that perform various media content manipulation processes described herein.

Client device 1518 receives a user input 1504 at input circuitry 1516. For example, client device 1518 may receive a user input like a user swipe or user touch, as previously discussed. In some embodiments, client device 1518 is a media device (or player), with the capability to access media content. It is understood that client device 1518 is not limited to the embodiments and methods shown and described herein. In non-limiting examples, the client device 1518 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other television equipment, computing equipment, or wireless device, and/or combination of the same.

User input 1504 may be received from a user selection-capturing interface that is separate from device 1518, such as a remote-control device, trackpad, or any other suitable user movement sensitive or capture devices, or as part of device 1518, such as a touchscreen of display 1534. Transmission of user input 1504 to client device 1518 may be accomplished using a wired connection, such as an audio cable, USB cable, ethernet cable, or the like attached to a corresponding input port at a local device, or may be accomplished using a wireless connection, such as BLUETOOTH, Wi-Fi, WiMAX, ZIGBEE, GSM, UTMS, CDMA, TDMA, 3G, 4G, 4G LTE, 5G, or any other suitable wireless transmission protocol. Input circuitry 1516 may comprise a physical input port such as a 3.5 mm audio jack, RCA audio jack, USB port, ethernet port, or any other suitable connection for receiving audio over a wired connection, or may comprise a wireless receiver configured to receive data via BLUETOOTH, Wi-Fi, WiMAX, ZIGBEE, GSM, UTMS, CDMA, TDMA, 3G, 4G, 4G LTE, 5G, or other wireless transmission protocols.

Processing circuitry 1540 may receive input 1504 from input circuit 1516. Processing circuitry 1540 may convert or translate the received user input 1504 that may be in the form of gestures or movement to digital signals. In some embodiments, input circuit 1516 performs the translation to digital signals. In some embodiments, processing circuitry 1540 (or processing circuitry 1526, as the case may be) carries out disclosed processes and methods.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods. In this specification, the following terms may be understood given the below explanations:

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent, or similar purpose unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

All of the features disclosed in this specification (including any accompanying claims, abstract, and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of modifying content for display at a user device during a pause event of media content, the method comprising:
determining, using control circuitry, contextual information of a media content item of the media content at the pause event;
determining, using control circuitry, a visual effect based at least in part on the contextual information;
generating, using control circuitry, a modified media content item based on the visual effect; and
displaying, using control circuitry, the modified media item content during the pause event.

2. The method of claim 1, further comprising:
obtaining, using control circuitry, image data from the media content item at the pause event; and
wherein the contextual information is based on the image data.

3. The method of claim 2, wherein the image data is obtained with an automatic content recognition technique, and the method further comprises:
receiving, using transceiver circuitry, a signal indicative of the pause event, wherein obtaining the image data is in response to receiving the signal indicative of the pause event.

4. The method of claim 1, wherein the media content item comprises metadata and the contextual information is determined from the metadata, and the method further comprises:
receiving, using transceiver circuitry, a signal indicative of the pause event, wherein the metadata is fetched in response to receiving the signal indicative of the pause event.

5. The method of claim 1, further comprising:
prior to the pause event, monitoring, using control circuitry, the media content for changes in contextual information;
storing, using control circuitry, the latest contextual information in cache; and
in response to receiving a signal indicative of the pause event, determining, using control circuitry, the contextual information at the pause event based on the contextual information in cache.

6. The method of claim 1, further comprising:
preloading a further media content item from the media content during the pause event in parallel to the displaying of the modified media content item during the pause event.

7. The method of claim 6, further comprising:
receiving, using transceiver circuitry, a signal indicative of a play command;
removing, using control circuitry, the visual effect; and
displaying, using control circuitry, the preloaded media content item.

8. The method of claim 1, further comprising:
retrieving, using transceiver circuitry, a user profile, the user profile indicative of a user-preferred visual effect;
storing, using control circuitry, the user-preferred visual effect in local storage on a user device; and
wherein determining the visual effect is based at least in part on the user-preferred visual effect.

9. The method of claim 1, wherein the visual effect comprises a teaser frame of the media content, and wherein the teaser frame is selected from a plurality of indicated media content frames.

10. The method of claim 1, further comprising:
determining user device capabilities;
in response to the user device capabilities being below a threshold, carrying out the method at least in part on a server communicatively coupled to the user device and/or a media content service; and
in response to the user device capabilities being above the threshold, carrying out the method at least in part on the user device.

11. A system comprising control circuitry, the control circuitry configured to:
determine contextual information of a media content item of the media content at the pause event;
determine a visual effect based at least in part on the contextual information;
generate a modified media content item based on the visual effect; and
display the modified media item content during the pause event.

12. The system of claim 11, the control circuitry configured to:
obtain image data from the media content item at the pause event; and
wherein the contextual information is based on the image data.

13. The system of claim 12, wherein the image data is obtained with an automatic content recognition technique, and the control circuitry configured to:
receive a signal indicative of the pause event, wherein obtaining the image data is in response to receiving the signal indicative of the pause event.

14. The system of claim 11, wherein the media content item comprises metadata and the contextual information is determined from the metadata, and the control circuitry configured to:
receive a signal indicative of the pause event, wherein the metadata is fetched in response to receiving the signal indicative of the pause event.

15. The system of claim 11, the control circuitry configured to:
prior to the pause event, monitor the media content for changes in contextual information;
store the latest contextual information in cache; and
in response to receiving a signal indicative of the pause event, determine the contextual information at the pause event based on the contextual information in cache.

16. The system of claim 11, the control circuitry configured to:
preloading a further media content item from the media content during the pause event in parallel to the displaying of the modified media content item during the pause event.

17. The system of claim 16, the control circuitry configured to:
receive a signal indicative of a play command;
removing the visual effect; and
display the preloaded media content item.

18. The system of claim 11, the control circuitry configured to:
retrieve a user profile, the user profile indicative of a user-preferred visual effect;
store the user-preferred visual effect in local storage on a user device; and
wherein determining the visual effect is based at least in part on the user-preferred visual effect.

19. The system of claim 11, wherein the visual effect comprises a teaser frame of the media content, and wherein the teaser frame is selected from a plurality of indicated media content frames.

20. The system of claim 11, the control circuitry configured to:
determine user device capabilities;
in response to the user device capabilities being below a threshold, send instructions to carry out a method at least in part on a server communicatively coupled to the user device and/or a media content service; and
in response to the user device capabilities being above the threshold, send instructions to carry out the method at least in part on the user device.

21-50. (canceled)
